(19) United States
(12) Patent Application Publication
(10) Pub. No.: US 2009/0106458 A1
(43) Pub. Date: Apr. 23, 2009

(54) IMAGING SYSTEM AND METHOD CAPABLE OF MANAGING FILE TRANSMISSION WITH EXTERNAL DEVICE

(75) Inventor: QING-FA OU, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/118,946

(22) Filed: May 12, 2008

(30) Foreign Application Priority Data
Oct. 23, 2007 (CN) 200710202225.5

(51) Int. Cl. G06F 3/00

(52) U.S. Cl. 710/8

(57) ABSTRACT

An imaging system includes an internal storage unit, a connection unit, a user interface, and a management unit. The internal storage unit is configured for storing a file. The connection unit is configured for connecting the imaging system to an external storage device, and thereby establishing a communication for file transmission therebetween. The user interface is configured for receiving file transmission parameters. The management unit is configured for managing the file transmission, based on the received file transmission parameters.

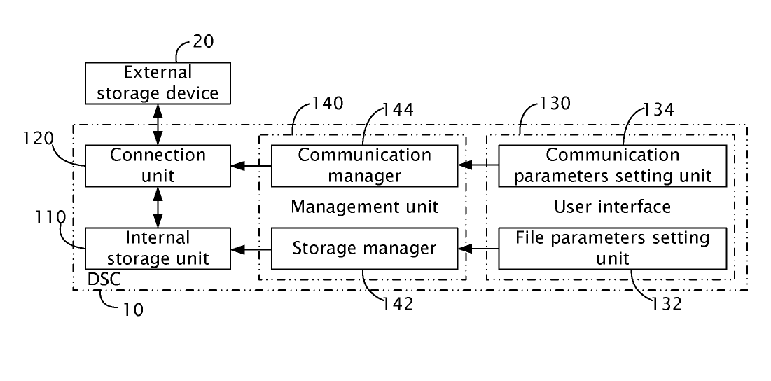

### BACKGROUND

1. Technical Field

The invention relates to imaging systems and methods, more particularly, to an imaging system and a method capable of managing file transmission with an external device.

2. Description of Related Art

Digital still cameras (DSCs) typically include an internal storage member such as a random-access memory or a non-volatile memory (e.g., a memory card) for storing photo or video files. Generally, such a DSC can be connected to a computer for exchanging files. In order to do so, a file transfer program is required and conventionally installed in the computer to manage the file transmission between the DSC and the computer. The DSC cannot exchange files with a non-computer external device without the assistance of the computer. However, it is inconvenient or difficult for a user to take along a computer at all times.

Therefore, it is desirable to provide an imaging system capable of managing file transmission with an external device, which imaging system can overcome the above mentioned problem.

### SUMMARY

In a present embodiment, a digital still camera (DSC) includes an internal storage unit, a connection unit, a user interface, and a management unit. The internal storage unit is configured for storing a file. The connection unit is configured for connecting the imaging system to an external storage device, and thereby establishing communication for file transmission therebetween. The user interface is configured for receiving file transmission parameters. The management unit is configured for managing the file transmission, based on the received file transmission parameters.

### BRIEF DESCRIPTION OF THE DRAWING

The FIGURE is a functional diagram of a digital still camera (DSC) capable of managing file transmission with an external device, according to an exemplary embodiment.

### DETAILED DESCRIPTION OF THE EMBODIMENTS

Preferred and exemplary embodiments of the present imaging system and data exchanging method will now be described in detail with reference to the drawing. In the following described embodiments, the imaging system is a digital still camera (DSC). However, the imaging system can also be a digital camcorder or any electronic device having image capturing function.

Referring to the figure, a DSC 10 in accordance with an exemplary embodiment includes an internal storage unit 110, a connection unit 120, a user interface 130, and a management unit 140. The internal storage unit 110 is configured for storing files. The connection unit 120 is configured for connecting the DSC 10 to an external storage device 20, and thereby establishing communication for file transmission between the DSC 10 and the external storage device 20. The user interface 130 is configured for receiving file transmission parameters. The management unit 140 is configured for managing the file transmission, based on the received file transmission parameters.

The internal storage unit 110 can include a memory device, e.g. a random-access memory (RAM) or a non-volatile memory card. The files can be stored in the internal storage unit 110, together with any relevant metadata such as file name, file size, and timestamp.

The connection unit 120 is configured for establishing a universal serial bus (USB) connection, an Institute of Electrical and Electronics Engineers (IEEE) 1394 connection, or a recommended standard (RS) 232 connection. Also, the connection unit 120 can establish a suitable wireless connection, for example, a radio frequency based connection (e.g. Bluetooth), or an infrared based connection. Accordingly, the external storage device 20 can be a portable electronic device having a storage member, such as a DSC, a mobile phone, or a multimedia player. In this embodiment, the connection unit 1 20 includes a card adaptor. The external storage device is a non-volatile memory card.

The user interface 130 includes a file parameters setting unit 132, and a communication parameters setting unit 134. The file parameters setting unit 132 is configured for receiving parameters of various file manipulations, e.g., parameters of building a new file, labeling (e.g., nominating) a file, and selecting a file. The communication parameters setting unit 134 is configured for receiving parameters of communication, e.g., communication modes (e.g., device-to-device connection, or device-to-card connection; pull-based transmission, or push-based transmission; direct insertion connection, USB connection, IEEE 1394 connection, RS 232 connection, Bluetooth-based connection, or infrared-based connection), transmission requests, and transmission rates. In practice, the user interface 130 can include an input unit (not shown, e.g., a key pad) for entering the abovementioned parameters, and a display unit (not shown) for displaying information of the internal storage unit 110 (e.g., current directory, list of files under the current directory, and available space) and the communication status (communication mode, and transmission rate).

The management unit 140 includes a storage manager 142, and a communication manager 144. The storage manager 142 is configured for managing the internal storage unit 110, based on the received parameters of file manipulation. The communication manager 144 is configured for managing the communication, based on the received parameters of communication. For example, the storage manager 142 can build a new file in the internal storage unit 110 for archiving downloaded (pull-based transmission) data, rename an existing file, and select an existing file, based on the received file parameters (e.g., file directory, file size, file properties, name string, and a locating indicator for the current file shown on the display unit). The communication manager 144 can determine the communication modes, initiate a transmission, and specify transmission rate, based on the received communication parameters (e.g., choices on menu(s), transmission request, and rate value).

Various components of the DSC 10 such as the connection unit 120 and the management unit 140 can be integrated into a single control unit. Alternatively, such components can instead be software instructions written via a variety of programming languages, including C, C++, Java, Visual Basic, and many others, and can be executed by hardware such as an FPGA or an ASIC to acquire the above-mentioned functionality of the components.

In use, the external storage device 20 is first connected to the DSC 10 via the connection unit 120. A file(s) is selected or built to be manipulated based on file parameters input via the user interface 130. Then, input of communication parameters (e.g., device-to-card, direct insertion, pull-based mode choices) is required to establish communication. Next, file transfer is initiated (transmission request is sent), and data is exchanged, based on the file and communication parameters.

It should be understood that the DSC 10 also can act as an assistant to data exchange between two or more external devices which cannot exchange their data with an external device by themselves. For example, the DSC 10 can help to copy or delete data stored in a memory card A to a memory card B, calling for the following steps: connecting the memory card A to the DSC 10; transferring the data stored in the memory card A to the internal storage unit 110; disconnecting the memory card A and the DSC 10; connecting the memory card B to the DSC 10; and transferring (push-based transmission) the previously stored data from the memory card A to the memory card B.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. An imaging system comprising:
an internal storage unit configured for storing a file;
a connection unit configured for connecting the imaging system to an external storage device, and thereby establishing a communication for file transmission therebetween;
a user interface configured for receiving file transmission parameters; and
a management unit configured for managing the file transmission, based on the received file transmission parameters.

2. The imaging system as claimed in claim 1, wherein the internal storage unit comprises a random-access memory.

3. The imaging system as claimed in claim 1, wherein the internal storage unit comprises a non-volatile memory card.

4. The imaging system as claimed in claim 1, wherein the connection unit comprises a card adaptor.

5. The imaging system as claimed in claim 1, wherein the connection unit is configured for establishing a connection between the imaging system and the external storage device, the connection being selected from a group consisting of: universal serial bus connection, IEEE 1394 connection, RS 232 connection, radio-frequency based connection, and infrared based connection.

6. The imaging system as claimed in claim 1, wherein the user interface comprises a file parameters setting unit, and a communication parameters setting unit, the file parameters setting unit being configured for receiving parameters of file manipulation, the communication parameters setting unit being configured for receiving parameters of communication.

7. The imaging system as claimed in claim 6, wherein the management unit comprises a storage manager, and a communication manager, the storage manager being configured for managing the internal storage unit based on the received parameters of file manipulation, the communication manager being configured for managing communication, based on the received parameters of communication.

8. A file transferring method comprising steps of:
connecting an imaging system to an external storage device, and thereby establishing a communication therebetween;
receiving file transmission parameters via the imaging system;
initiating a file transmission by the imaging system based on the received parameters; and
performing the file transmission.

9. The file transferring method as claimed in claim 8, wherein the imaging system comprises a random-access memory.

10. The file transferring method as claimed in claim 8, wherein the imaging system comprises a non-volatile memory card.

11. The file transferring method as claimed in claim 8, wherein the imaging system comprises a card adaptor.

12. The file transferring method as claimed in claim 8, wherein the connection is selected from a group consisting of: universal serial bus connection, IEEE 1394 connection, RS 232 connection, radio-frequency based connection, and infrared based connection.

13. The file transferring method as claimed in claim 8, wherein the file transmission is a pull-based transmission.

14. The file transferring method as claimed in claim 8, wherein the file transmission is a push-based transmission.
